(19) United States
(12) Patent Application Publication
(10) Pub. No.: US 2007/0067275 A1
(43) Pub. Date: Mar. 22, 2007

(54) Context sensitive web search queries

(75) Inventor: Oded Y. Shekel, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/230,861

(22) Filed: Sep. 20, 2005

(51) Int. Cl. G06F 17/30

(52) U.S. Cl. 707/4

(57) ABSTRACT

A computer-implemented system that facilitates establishing price(s) associated with items comprises a clustering component that clusters a collection of non-identical items into one or more sets of non-identical items. A pricing component receives one or more of active bids and stored bids and simulates an auction of at least one non-identical item within one of the one or more sets of non-identical items as if the non-identical items within the set were identical to determine price(s) associated with the at least one non-identical item. For example, the items can be at least portions of search terms received by a search engine.

### BACKGROUND

As computer applications have become highly complex, user help files associated with the computer applications have changed accordingly. Although application help files can contain a multitude of information relating to their associated programs, confining user help information in the application has many inefficiencies. Since the help file is confined within the boundaries of the program, the information contained therein is finite and static. Additionally, conventional help files fail to take into account user context when performing searches related to program functionality. Moreover, creating user help files requires inefficient user of resources in the form of time, effort, and money.

The conventional method of structuring user help files is to encapsulate the help file in its associated application. A common method of access to user help is to include a help menu in the form of a drop down menu. The drop down menu can open a user help file database and a user can interface with the database to find out desired information. In addition to a menu based method of help file access, many drop downs and popup windows offer the user a help button. Selection of the help button opens a help file, where the user can be assisted in performing operations related to the drop down menu. However, as a help file can contain basic instructions on how to perform certain program-related activities, they may not contain enough background information to explain to the user all the nuances of such activities. For instance, if a user needs help in naming a file, the user could click the help button on a window that provides a user interface for naming a file. However, while the interface may explain how to name a file, the database may not contain information that explains the nuances of naming a file.

The above example shows one of the shortcomings of conventional application related help files. Since the files are embedded in an application, they are isolated from the outside world. The Internet has illustrated that information is constantly transforming and evolving. The Internet has provided for increased speed of learning, based in part on the limitless and constantly developing information that it holds.

Conversely, a traditional user help file illustrates an example of the antithesis of a dynamic learning environment that can adapt to user needs. In more detail, the confinement of help related information to a datastore confined within a program offers a finite amount of information. Since the amount of information is limited to what is contained in the program when the software is sold, the user help file cannot adapt to the user employing it. For instance, a user unfamiliar with a program may need information relating to much more than how to perform a specific function. A user new to an application first may need to know much more than how to execute a particular task. A new user, starting with a tabula rasa or “blank slate” with regard to knowledge of the program, may first need to learn the capabilities of the program. Once the user knows the capabilities of a program, the user next may need to learn the terminology of the program necessary to take advantage of the newly discovered capabilities. Program capabilities and terminology are just two examples of knowledge needed by the user in order to even begin to use conventional help files effectively.

Another deficiency to conventional user help functions is the traditional index function. The aforementioned user lack of knowledge of terminology illustrates one of the shortcomings of the index function. If the user does not know the specific name or key word of the functionality that the user wishes to employ, then the user faces difficulty in searching for help relating to the functionality. The lack of knowledge related to application terminology is compounded with another deficiency of conventional help indices. The index function loses the user context information of the application. In greater detail, when a user opens the help function and proceeds to an index screen, the conventional search fields are initially blank. As such, the user starts from the same place for every search within the help function. In one example, if a user wants to find a synonym for “good,” but does not know to use the term “thesaurus” in the search, the help function can prove very inefficient with regard to user time and effort to find the requisite information. To alleviate the user's unfamiliarity with specific help terms, many help files can also include a table of contents as an alternative means to access a help database. However, after a seemingly easy start, a user can quickly get lost in a maze of information, much of which only serves to confuse a user with unfamiliar terminology and a minimum of context in which to place the help instructions.

Some programs require the user to access the Internet in order to learn about information relating to the program. Other times, the user turns to the Internet out of frustration with the associated application help file. Whatever the condition that guides a user to access the Internet to perform a search may be, this type of search is far from perfect. A user accessing the Internet remains in the same position as the user accessing the index or table of contents on an important way. In each type of search, the user starts from the same place. The search requires the user to supply the context of the program, operating system, user history, etc. Forcing the user to generate context in this manner proves inefficient, as context information is lost between the program and the Internet search.

Encapsulating a user help file within a program is also inefficient. As user help files can contain a large amount of information, organizing the information and placing it within the confines of the program requires much time, money, and effort. Aside from collecting and organizing the information, the help file requires the testing, debugging, etc. required for the development of any piece of software. Additionally, including the large help file in the application requires more disk space, translating to increased production costs. Also mentionable are the costs associated with maintaining and keeping the information up to date.

Furthermore, confining the help file within the program limits the interaction that third party vendors can have with user with regard to the program. To illustrate one drawback, conventional user help files to not contain advertisements. Placing the user help file in another medium, such as the Internet, enables the user to interface with additional sources of information that can further enhance the user application experience.

Generally, the idea of encapsulating the user help file within a program application is outdated. The idea of an application containing a help file likely traces its roots back to the advent of personal computers. At that time, user access to program information was limited to the program itself. Since the Internet and the associated speed of data exchange was still in relative infancy, accessing large help files via the Internet was an improper method to offer user help. As such, including the user help file in a program seems to be a holdover of previous generations of computing.

In view of at least the aforementioned shortcomings associated with conventional assistance/search schemes, there is a strong need in the art for systems and methods that mitigate such limitations.

### SUMMARY

The following presents a simplified summary of the claimed subject matter in order to provide a basic understanding of some aspects of such subject matter. This summary is not an extensive overview, and is not intended to identify key/critical elements of the claimed subject or to delineate the scope thereof. Its sole purpose is to present some concepts in a simplified form as a prelude to the more detailed description that is presented later.

The subject invention relates generally to enhancing user help by providing context sensitive web search queries. As conventional help files offer many inefficiencies that serve as barriers between a user and desired information, the subject invention overcomes many of the barriers associated with conventional help files. The best resource that software producers can use to answer questions users might have when using their software is the Internet. The invention facilitates defining user state and context and associates information related to user state and context with a search query. One exemplary embodiment enhances help functionality by replacing the “help” buttons in each dialog box with a link to a context-dependent user help site on the Internet.

In accordance with one exemplary embodiment, a context component can save or cache information relating to application aspects such as for example user state, context, intent, and application state. Such information may include, but is not limited to, operating system information, program information, menu information, and historical information. As a user interacts with an application, the interaction of the user can be recorded by the context component. The system can also employ a search component that receives information saved by the context component. Upon indication from the user that help is required with regard to a certain aspect of the user application, the search component can perform a web-based search to retrieve desired information. Additionally, the information collected by the context component can be included in search fields in order to enhance and focus user search.

The context sensitive web query offers improvements over conventional user help files. If a user accessed the index of a user help file, the user will start with a blank search field at the beginning of the index structure. The subject invention offers an improvement over the convention index methodology by automatically entering user context into a search field. Thus, users are not required to generate search terms on their own, or worse to pick search terms from thin air. Filling in and/or appending search fields (e.g., with meta data) with context sensitive information also ensures that no information is lost when the user performs a search. Since no important context information is lost and conversely most useful and/or necessary context information is included with the search fields, the user is much more likely to encounter a satisfactory search result.

The subject invention also allows a user to edit a search query. In one aspect, the user is made aware of (e.g., viewing, hearing . . . ) search terms upon initiating a search. As such, the user is able to add or remove search terms in order to better tailor the search to return desired results. Filters can be employed to broaden or narrow the search, or to search specific sites or to add various sites to the search component.

The subject invention can also be used to update an application datastore with results of search queries. The datastore can contain information related to user help functions. Thus, the application can be optimized to offer more satisfactory results for future searches of the same application state. In accordance with one particular method of updating the application datastore, context sensitive web queries can be run continuously or dynamically to update a number of facets associated with user assistance. Such continuous/dynamic search can provide pre-fetch functionality. As the user encounters a scenario for which the user requires help, the user can indicate that help is needed and the prefetched results can immediately be offered to the user. Such updating of user help databases can also be valuable for devices that are periodically isolated from the Internet. When the device has Internet connectivity, a continuous search could be executed such that the user help datastore can offer comprehensive user help. Thus, when the device does not have Internet connectivity, or perhaps slow Internet connectivity that makes a web search impractical, the comprehensive datastore could act as a suitable replacement to provide user help. Such functionality can be useful for mobile devices. Additionally, the created comprehensive help databases can be transferred from one device to another, and integrated with other databases, as to further synthesize a database that contains comprehensive application help capabilities.

The subject invention also allows for advertisers to interact with users performing the web queries. Advertisers can buy certain search terms or web queries. Additionally, software vendors can purchase the services of certain search engines to perform the search queries. Conversely, search engine vendors can purchase the exclusive right to perform searches associated with user applications. Additionally, advertisers can include banner advertisements and links to information that may further enhance and improve the user experience. One such example to be provided not for limitation but for illustration is for an advertiser to include in a search return an advertisement for a program that offers an improvement on a limitation of the user application.

To the accomplishment of the foregoing and related ends, certain illustrative aspects of the claimed subject matter are described herein in connection with the following description and the annexed drawings. These aspects are indicative, however, of but a few of the various ways in which the principles of the invention may be employed and the subject matter recited in the claims is intended to include all such aspects and their equivalents. Other advantages and novel features may become apparent from the following detailed description when considered in conjunction with the drawings.

### BRIEF DESCRIPTION OF THE DRAWINGS

FIG. 1 is a high-level block diagram of a system that facilitates search using context sensitive web queries.

FIG. 2 is a block diagram of a system that enhances user help by providing context sensitive searches.

FIG. 3 is a representative flow diagram illustrating a methodology for performing a context sensitive search query.

FIG. 4 is a representative flow diagram illustrating a methodology for collecting context sensitive information.

FIG. 5 is a representative flow diagram illustrating a methodology for anticipating a user help request.

FIG. 6 illustrates several user interfaces in accordance with an aspect of the subject invention.

FIG. 7 is a representative flow diagram illustrating a methodology for anticipating a user help request.

FIG. 8 is a representative flow diagram illustrating a methodology for including advertising in context sensitive search queries.

FIG. 9 is an exemplary page view of a context sensitive web search result.

FIG. 10 is an exemplary page view of a context sensitive web search result.

FIG. 11 is a schematic block diagram illustrating a suitable operating environment.

FIG. 12 is a schematic block diagram of a sample-computing environment.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the claimed subject matter. It may be evident, however, that such subject matter may be practiced without these specific details. In other instances, well-known structures and devices are shown in block diagram form in order to facilitate describing the subject matter as recited in the claims.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Furthermore, the claimed subject matter may be implemented as a method, apparatus, or article of manufacture using standard programming and/or engineering techniques to produce software, firmware, hardware, or any combination thereof to control a computer to implement features disclosed herein. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

Various inference schemes and/or techniques in connection with dynamically generating search queries can be employed in connection with embodiments described herein. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Accordingly, it is contemplated that users can be automatically assisted with applications in accordance with the embodiments described herein. Automatic action (e.g., seamlessly transitioning a user during an assistance session) can be taken as a function of inferring a user's intentions with respect to employment of an application as well as tertiary actions, passive/background communications, and upcoming interaction, for example. With respect to taking automatic action, machine learning techniques can be implemented to facilitate performing automatic action. Moreover, utility based analyses (e.g., factoring benefit of taking correct automatic action versus costs of taking incorrect action) can be incorporated into performing the automatic action. More particularly, these artificial intelligence (AI) based aspects can be implemented by any suitable machine-learning based technique and/or statistical-based techniques and/or probabilistic-based techniques. For example, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, . . . are contemplated and are intended to fall within the scope of the hereto appended claims. It is to be appreciated as well as readily apparent that many of the components (e.g., context component, search component) described herein can employ AI in connection with the functionalities associated therewith.

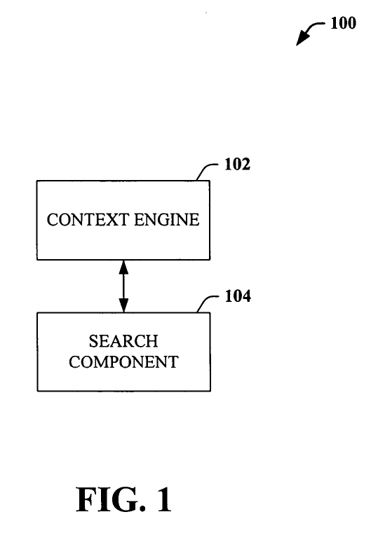

The claimed subject matter will now be described with respect to the drawings, where like numerals represent like elements throughout. The subject invention generally relates to novel systems, methods, articles of manufacture, and/or apparatuses that enhance user help by providing context sensitive search queries. For instance, if a user running an application encounters an unfamiliar menu item, or is unsure how to perform a certain task, the user can perform a search that includes application context information in the query fields. Referring now to FIG. 1, a system 100 that facilitates context sensitive web search is illustrated. The system 100 includes a context component 102 that analyzes and processes information related to user state, context, intent, and application state. For instance, the information can be operating system information, program information, menu information, application information, and historical information. The operating system information includes the software operating platform on which the application is running. Examples include Microsoft Windows, Unix, Linux, MacOS, Solaris, MS-DOS, CP/M, and AmigaOS. The menu information can include information relating to user position within the menu system of the program application. Examples of program information can include the name, release, version, updates, and patches associated with the user program. Examples of historical information can be similar situations encountered by the user in the past, as well as previous use of the application. Generally, the context component 102 can save or cache information that can be useful when included in a web search to assist the user in locating desired information.

The system further includes a search component 104. The search component performs a search in connection with information provided by the context component 102 to search for information to assist the user to obtain information associated with interacting with a user application. The search component 104 can include and/or interact with a search engine configured to search the Internet as well as Intranet(s). Search queries, terms and/or criteria generated by the search component 104 can be augmented, modified, associated with information gathered at least in part by the context engine 102. Moreover it is to be appreciated that the search component can filter results as a function of information provided by the context component. The term “search terms” is intended to include a word, a phrase, a search query, a particular portion of a search query (e.g., a prefix comprising a threshold number of words or spaces, a suffix comprising a threshold number of words or spaces, . . . ). As stated supra, such information can include operating system information, program information, menu information, and historical information.

To illustrate by example, suppose a user is employing Microsoft Word 2003®. As the user is creating a document, the user decides that a drop cap function would enhance document aesthetics. To initiate the drop cap function, the user would select Tools →Drop Cap. Upon initiating the drop cap menu selection, a window appears that enables the user to make several decisions relating to the drop cap function, such as the position of the drop cap letter, the font options, number of line to drop, distance from text, and the like. However, the user may not understand what all the options mean, how they are implemented, or perhaps a user desired option is not readily apparent from the window. The subject invention can present an interface to execute the following web query: Office 2003, Word, Drop Cap. It is to be understood that the context component 102 can collect the menu terms that are useful in obtaining information relating to the Drop Cap window. It is also to be understood that the context component 102 can automatically input the useful menu terms into search fields of the search component 104 without requiring the user to decide what terms are important to use in the search query. Moreover, such context information can be presented in a manner transparent to the user (e.g., use of metadata that is appended to the search query). Additionally, and optionally the context information can be employed to select most appropriate terms for a query so as to facilitate generating meaningful search results that are coincident with assisting a user in an optimal manner. As such the user is provided with information most likely to be helpful without deciding what search terms to use, inputting the search terms in the search query, etc. Furthermore, a web query can be launched from a specific GUI component using the context as the query words.

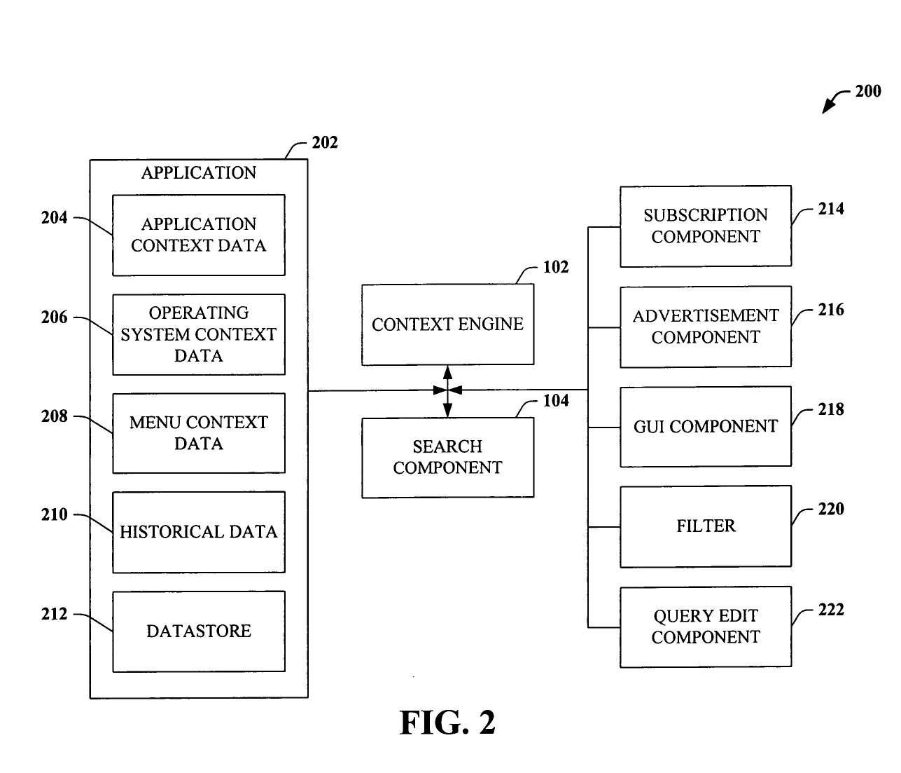

Turning now to FIG. 2, a system that enhances user help by providing a context sensitive search query is illustrated. The system includes an application 202 that a user is employing to accomplish a given task. While using the application 202, the context engine 102 can collect useful data relating to specific functions of the application 202-application data 204 is an example of such useful data. As mentioned supra, the application data 204 can be information relating to the program, such as the program name, revision, patches downloaded, etc. Operating system context data 206 can also be applicable to a search query. The menu context data 208 can include a path from the menu system to the desired function. An example of the menu context data 208 was presented above, that of including ‘format’ and ‘drop caps’ in a web search query about application information relating to Drop Cap functionality.

Historical data 210 can also be included. One such example of historical data 210 can be a previous search made relating to similar program functionality. For example, returning to the Drop Caps example, suppose the user previously performed a search initiated from the same menu. In one aspect of the subject invention, user feedback functionality can be included. In more detail, upon the receipt of search results from the search component 104 the user can input via a graphical user interface (GUI) whether the returned results were helpful. If the results were deemed unhelpful, the user could perform more searches until a helpful result was obtained. Once the user receives a helpful result, the historical data component 210 can save the search terms used to obtain the helpful result, and include those saved search terms when launching future web queries from the Drop Caps menu.

The application can also contain a datastore 212. The datastore can be a traditional help application encapsulated within the application. As presented supra, the subject invention can improve upon deficiencies of conventional datastores. These deficiencies can include expenses related to developing, maintaining, and keeping information up to date, as well as the limited amount of information that may not provide sufficient assistance to the user. Additionally, such datastore(s) typically do not take advantage of information located on the Internet. In one aspect of the subject invention, the search engine 104 can populate the datastore 212 with search results. Initially, the Internet can contain more information related to a program application than the application help file. However, after repeated searches the amount information contained in the datastore 212 can approach that of the Internet.

Updating the datastore can confer many benefits to the user. As the datastore 212 can be expanded to contain vast amounts of information, the user can be rewarded with a comprehensive help query system even if the user is isolated from the Internet. In one example, suppose that the user is running an application on a mobile device, such as a pocket PC. If the device has Internet connectivity, in can supplement information contained in the datastore 212 via context sensitive web search queries. At a later time, suppose the device is isolated from the Internet. Information not originally contained in the datastore but incorporated into the datastore via the context sensitive search queries can now be available to assist the user.

Additionally, the datastore 212 update can be combined with the historical data component 210 to filter additions to the datastore such that only additions that the user deemed to be helpful, or above a certain user satisfaction rating, will be incorporated. An extension of the cooperative functionality between the datastore 212 and the historical data component 210 is that the application is made intelligent for future searches of the same state, and it is also optimizes help to the user with the selective additions to the datastore 212.

The subject invention presents opportunity for advertisers to purchase use of various aspects and benefits thereof. One such aspect can be a subscription component. The subscription component 214 can relate employment of a specific search component 104. The search component 104 can be an application specific search engine, but it can also be any search engine capable of performing a web search. For example, a third party that creates a search engine can negotiate with an application producer to use the search engine in association with context sensitive web queries launched from the application producer's program. Conversely, a company that creates a program can pay for use of a specific search engine to perform the web queries. Thus, when a user encounters a situation where it would be beneficial to employ a context sensitive web search, the context component 102 can include useful user context, intent and application state information and supply the information to a search engine such that the search engine can perform the context sensitive web search. Benefits of such functionality are readily apparent to all involved parties. A software producer that does not write applications relating to search engines can receive the enhanced user help benefits derived from the context sensitive search queries through the use of a search engine produced by a third party. Alternatively, the third party can appreciate the benefits of increased use of their search engine. Additionally, even if the third party does not produce applications similar to the one employing the context sensitive web search, the third party can still profit from use of such an application. The same relates to the application writer that does not produce search engines in that the application writer benefits from the use of a search engine.

The advertisement component 216 also provides for advertisement interactions. In one aspect of the subject invention, an advertiser can purchase specific queries, query terms, and the like. As such, when context sensitive web search results are returned, the advertiser can link an advertisement relating to the search. One method of advertising can be incorporation of a banner ad advertising a program that has similar functionality as the context sensitive search terms included in the search. Another example can be Internet links that contain more information relating to the search. In general, advertisers and application vendors can negotiate to include in the context sensitive search query results material the advertiser wants to display to the user.

Another example can be a link to a program that can augment the functionality of the user application. For example, suppose that a user is creating complex equations using a word processing program. If a user performs a context sensitive search relating to equation conversion, an advertiser can include in the search result a program that is more convenient to generate and display equations, and incorporate the equations into the user application. The advertisement can include demo versions of a program, purchase information, and the like. Such an advertisement can serve to enhance the application being employed by the user.

A GUI component 218 can be employed to initiate context sensitive web search queries. Some examples of the GUI component 218 can be a button that initiates a web search or a link that takes a user to a web search. The link can also move a user to a search engine that automatically includes context related information in the search fields. Additionally, in the event of a user help search, some programs provide user unsatisfactory responses, for instance, “No results for your request were found. Please go to help.com for up to date information.” This relatively unhelpful message can be replaced with a link to a web search including the exact phrase and context related information for which the user was searching.

A filter 220 can be included to further focus the context specific web search. Where a context engine component 102 inputs context related application information into a search query, the filter 220 can be used to limit queries to specific sites. The filter 220 can also be used to broaden the web search. The filter 220 can also be used in conjunction with the advertisement component 216. Advertisers can pay to limit searches to specific sites. Conversely, advertisers may wish to include certain sites in the search. A query edit component 222 can also be used to further enhance user control over search functionality. For example, a user can peruse the information gathered by the context engine component 102 and choose to augment the search with additional terms. On the other hand, a user can remove terms from the search in order to obtain a search result more favorable to the user.

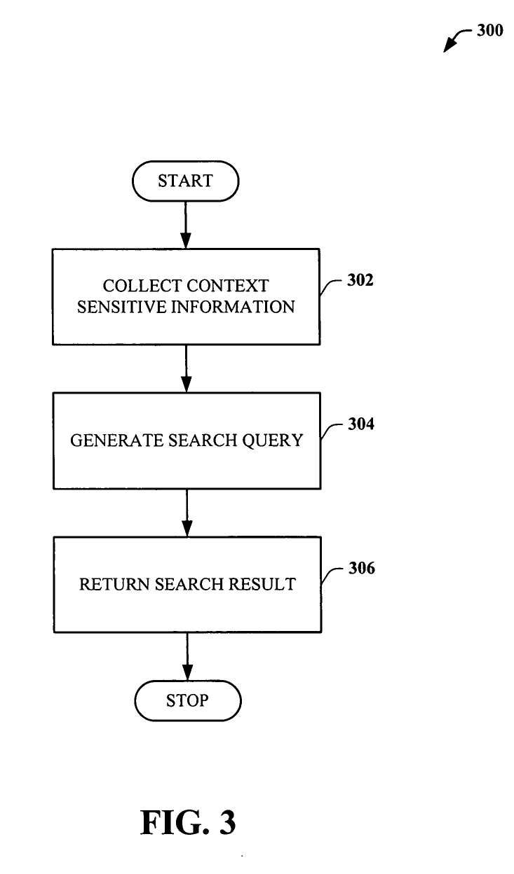

Referring now to FIGS. 3-5, methodologies in accordance with the claimed subject matter will now be described by way of a series of acts. It is to be understood and appreciated that the following description is not limited by the order of acts, as some acts may, in accordance with the claimed subject matter, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 3, a methodology 300 for performing a context sensitive web search query is illustrated. At 302, context sensitive information is collected. It is to be appreciated that context sensitive information can be collected upon prompting by the user via a GUI. The context sensitive information can include operating system information, program information, menu information, and historical information. Additionally, the context sensitive information be collected continuously as the user interfaces with the application. Once the context sensitive information is collected, a search query can be generated at 304. The search query can include context sensitive information collected in 302. The search query can also include terms supplied by the user or other source. The search query can employ a search engine encapsulated within the program. Alternatively, the search query can employ any search engine capable of searching the Internet for the search terms. At 306, search results are returned. It is to be appreciated that the search results can be returned when the user indicates that a web search be performed. Additionally, it is to be appreciated that the application can continually perform searches, and thus only return results to the user when prompted to do so. Meanwhile, the searches can be used to populate an application datastore to augment the local user help file.

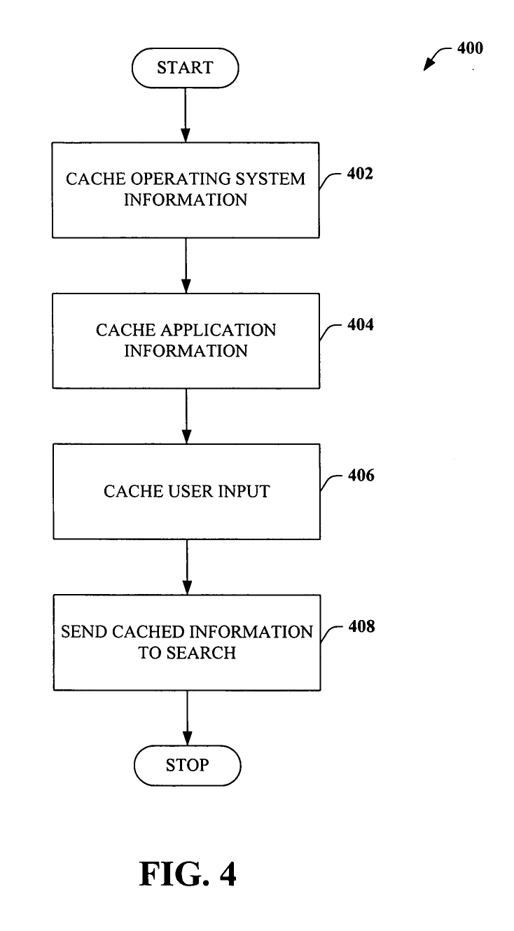

Turning now to FIG. 4, a methodology 400 for collecting context sensitive information is depicted. At 402, operating system information is cached. At 404, the application information is saved. Such information can include application name, type, version, patches, and the like. At 406, user input is saved—such user input can include the user task. Additionally, the user information can include the menu selections and keystrokes input into the application prior to selecting to perform a context sensitive search query. Other user information can include previous results from web queries containing similar search terms. Additionally, the previous results can be rated by the user in order to include the most helpful search terms from previous queries.

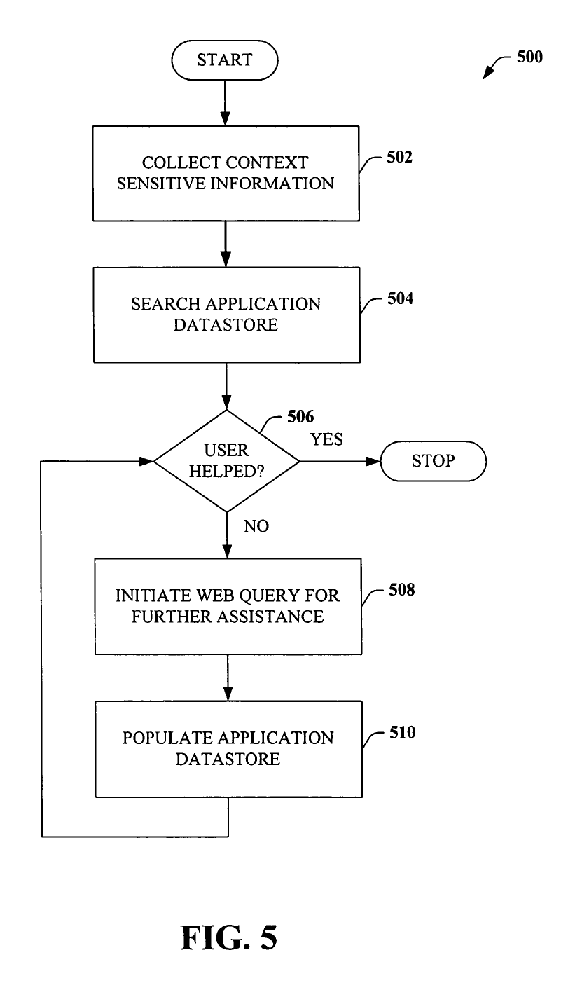

Referring now to FIG. 5, a methodology 500 for optimizing use of an application datastore is illustrated. At 502, context sensitive information is collected. Such collection of context sensitive information can be carried out in a similar method to that set forth in methodology 400. It is to be appreciated that the collection of context sensitive information is not limited to that of methodology 400. At 504, a user can search an application datastore using context sensitive information collected in 502. If the search of the datastore returns satisfactory results, the user can complete the search process, and use the information returned in the search to accomplish the desired task. However, if the search did not return helpful results from the application datastore, a web query can be launched at 508. The web query can contain the same search terms used to search the application datastore. Additionally, the search terms can be augmented by the user to further tailor the results of the search. The search engine employed to perform a search can be one set by default by the application or application programmer, or the search engine can be a third party search engine. Such search services can be purchased by the application programmer, or the search services can compensate the application programmer to be employed by the application in the web search.

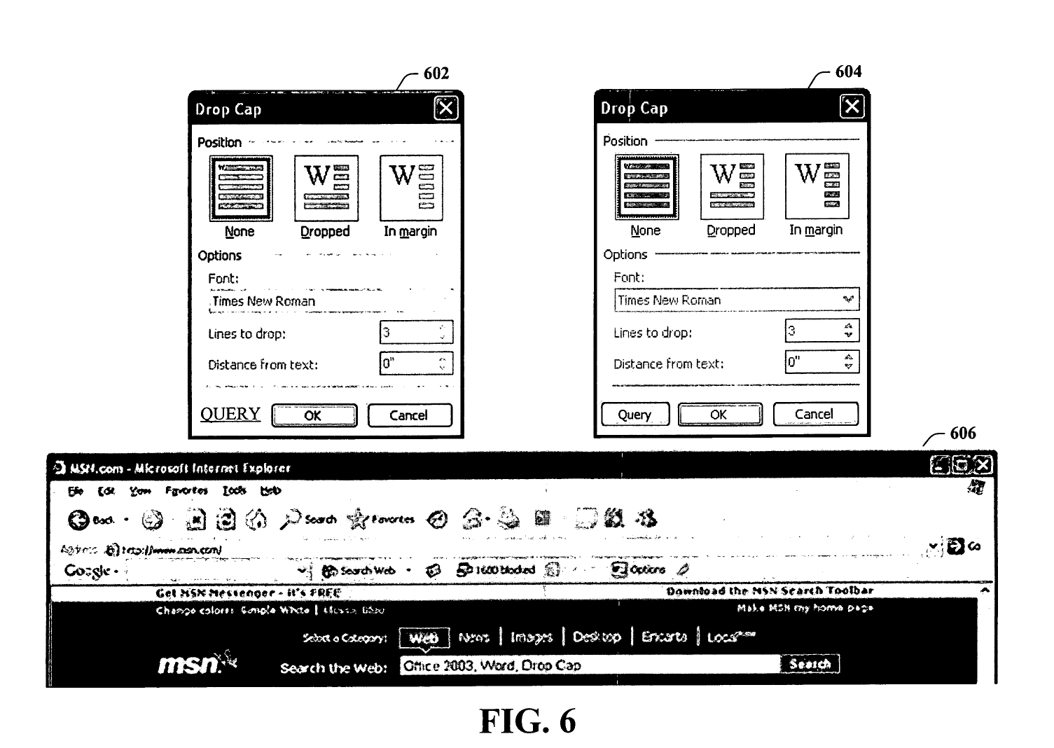

Turning now to FIG. 6, there are several illustrations of a GUI used to implement a context sensitive web search. Illustration 602 depicts the aforementioned Drop Cap menu that includes a link to a query. Depiction 604 illustrates the Drop Cap menu that includes a query button. It is to be appreciated that the link or the button can immediately execute a context sensitive web search. It is also to be appreciated that the link or button can instead redirect the user to a search engine. An example of such a redirection can is depicted at 606. Upon redirection to a search engine, the search fields can be automatically updated to include information related to user content, intent, and application state.

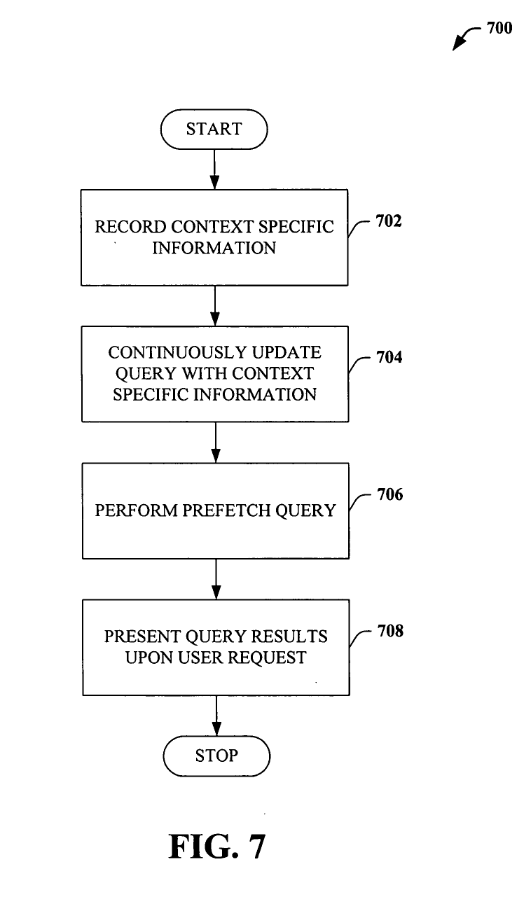

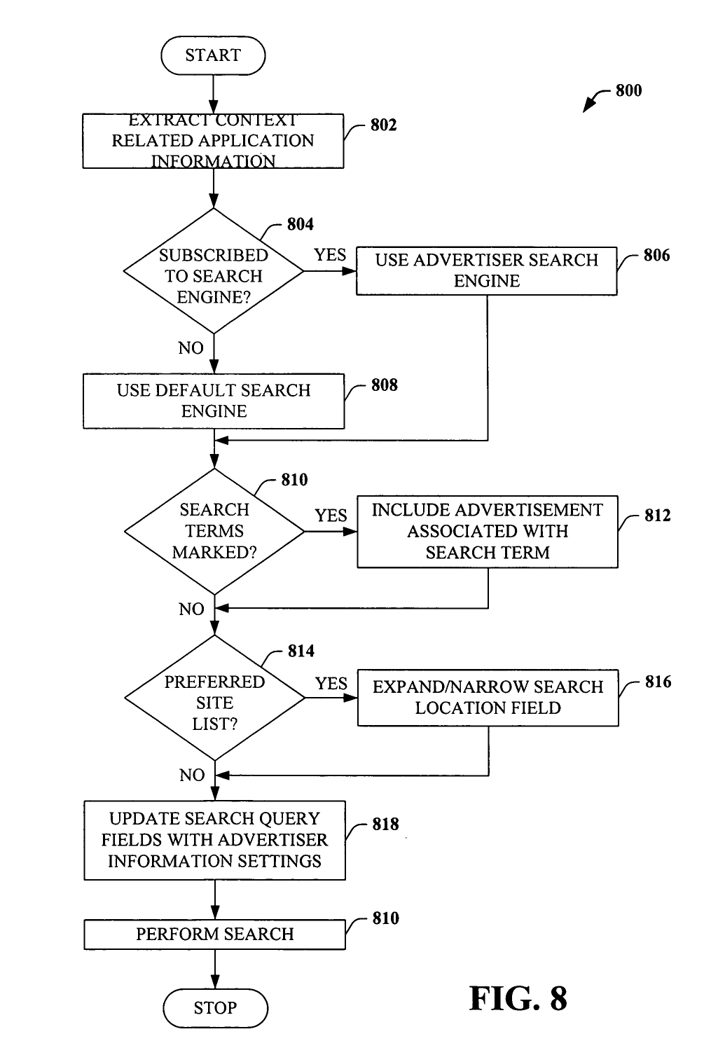

Referring now to FIGS. 7-8, methodologies in accordance with the claimed subject matter will now be described by way of a series of acts. It is to be understood and appreciated that the following description is not limited by the order of acts, as some acts may, in accordance with the claimed subject matter, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, a methodology 700 for anticipating a user help request is presented. According to one aspect of subject invention, a web query can return search results to a user only when prompted. That is to say, a web search can be performed on a continuous basis. However, the results can be returned to the user at designated times, rather than on a continuous base. At 702, context specific information is recorded. At 704, a web query is continuously updated with the context specific information. At 706, a prefetch query is performed. It is to be appreciated that the prefetch query can be performed in a manner transparent and/or invisible to the user. The prefetch query can be continuously performed, with the search engine acquiring search results on a correspondingly continuous basis. At 708, query results can be presented to the user upon request. A user request can be the user employing a GUI to indicate that the user would like help related to a certain aspect of the application. Two examples of the GUI can be seen in illustrations 602 and 604 of FIG. 6.

Continuing now to FIG. 8, a methodology 800 for including advertisements in query returns is illustrated. As presented supra, in one aspect of the subject invention advertisers can purchase various search features in order to display information to a user. At 802, context related application information is extracted. At 804, a decision block that determines whether a search engine is subscribed to perform the web search. If a particular search engine is subscribed to perform the search, then that requisite search engine can be used. It is to be appreciated that the party responsible for the search engine can purchase the right to associate the search engine with the web search. Alternatively, it is to be appreciated that the party responsible for the application can also purchase the right to associate the search engine with the web search. If no search engine is subscribed to perform the search, a default search engine is selected at 808.

Another decision block is located at 810. In addition to purchasing the right to use a certain search engine, search queries as well as individual search terms can be purchased. For example, if a query contains the terms “equation conversion,” an advertiser for a program that converts equations can purchase those terms and include an advertisement in the search results. The advertisement can be a banner advertisement, a link to a related site, and the like. Advertisers can be free to associate a wide variety of information with search query terms, and the examples of banner advertisements and links are provided illustrate examples rather than limitations. If the search terms in the web query are marked, then the requisite advertisement can be included with the search at 812.

Another decision block resides at 814. This decision block determines the sites searchable by the web query. In addition to associating web queries with advertisements, the web queries can also be associated with a field of searchable sites. For example, returning to the example of equation conversion, a software provider of equation converting software may include a search of the software provider's website, or sites that include information about the software provider's programs. Alternatively, a software provider can also narrow a search field to include sites that provide help to the user application, but the sites are provided by the software provider, rather than the application programmer. At 818, the search query can be updated with the corresponding changes presented above and at 820 a search can be performed.

To illustrate by example, suppose a user seeks help with a particular aspect of an application. The user could initiate a web search via a GUI. This web search could be modified by several advertising components that could be transparent to the user, or the user could be prompted to accept or reject advertisements from the advertisers. Upon indication via the GUI that a search be performed, suppose that company FASTSearch has been contracted as the primary search engine to be used. Upon execution of a search, FASTSearch's search engine will be used instead of the default application search engine. Additionally, suppose that company Delta has purchased the search terms “Font” and “Arial.” If a user initiates a web query including at least one term purchased by Delta, or perhaps all the terms purchased by Delta—depending on the agreement, then Delta can include in the search return an advertisement for a font that could be downloaded and used in place of Arial. Further suppose that company Tribal has arranged for several sites to be placed on the preferred site list to be searched during a web query. A search return from the Tribal pages could include other fonts that may be desirable by the user. The example above is provided to illustrate one possibility of the flexibility of the inclusion of aspects of advertising in conjunction with context sensitive web queries and is not intended show one possibility rather than to limit the scope of the subject invention.

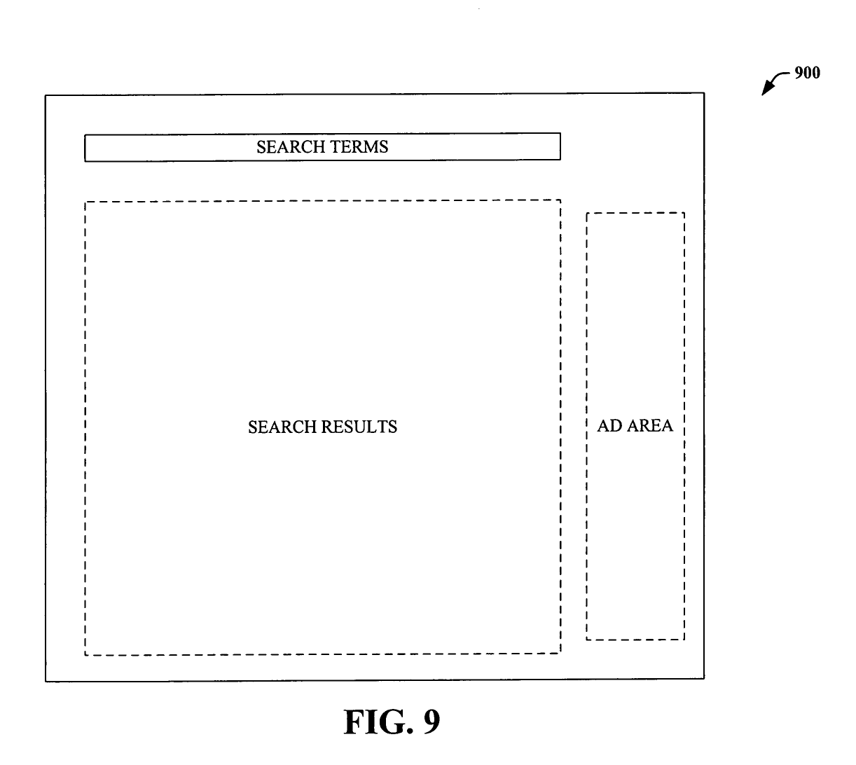

Turning now to FIG. 9, a depiction of a search result 900 is illustrated. The search result can be in the form of a standard web browser search return. For example, the search results can dominate the central part of a user display. The search terms can be illustrated at the top of the page. This can allow a user to modify a search by altering terms contained in the search field. If a user performed a search and sees from the results that important elements of what the user is looking for are not included, the user can modify the search field at the top of the user display accordingly. Additionally, there can be an ad area off to the side of the user display that can contain information relevant to the search terms. Thus the user can be presented with a large amount of information related to a particular feature of an application in an organized and familiar manner.

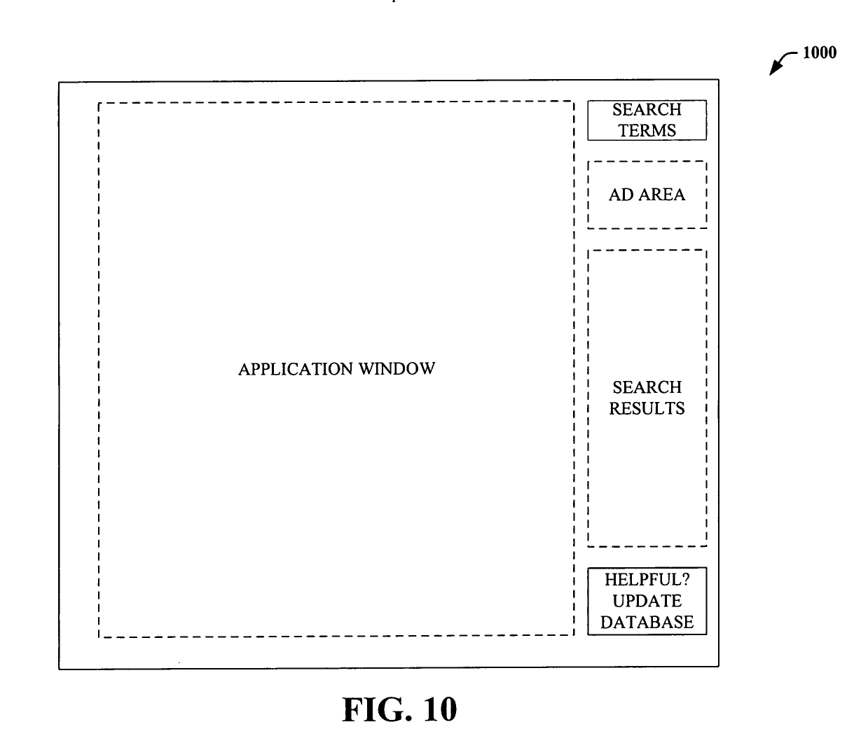

FIG. 10 illustrates an alternative description of a search result. The search return can be encapsulated in the application window. Accordingly display and interface related to the context sensitive web query can be presented off to the side, as not to obscure the main application screen. The search terms can be included, such that they can be altered in the event of an unsatisfactory search return. Additionally an advertisement area can be included below the search results. The ads can contain useful links to augment application features. The search results can be located below the advertisements, or vice versa. There can also be a user interface to determine whether the search returned useful information to the user. Accordingly, a context collecting component can include context from previously executed searches that obtained satisfactory results.

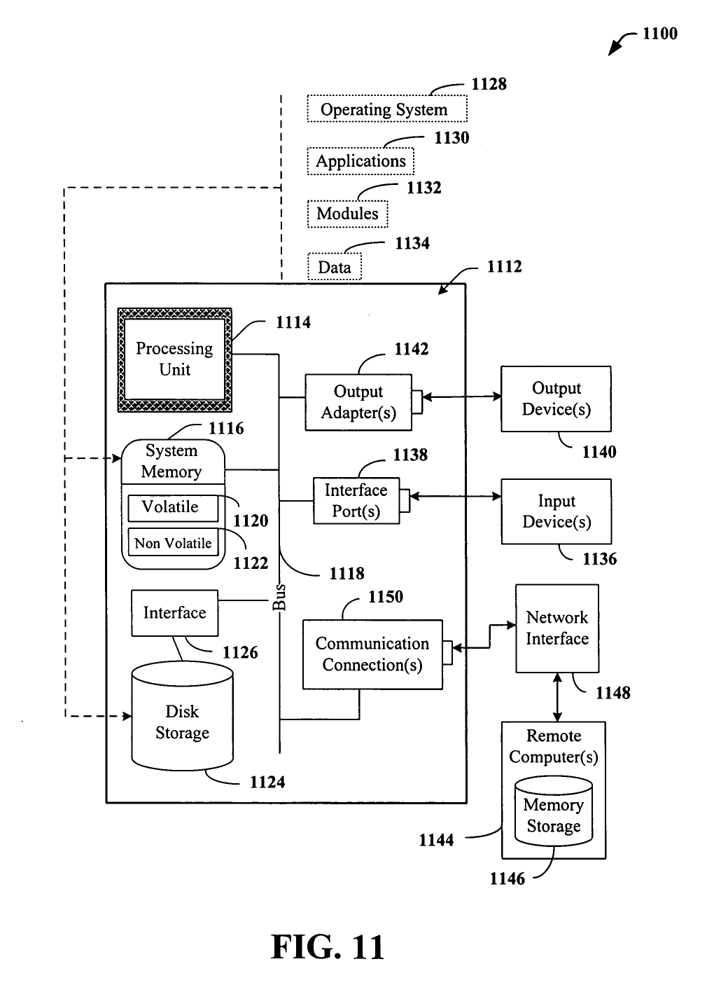

In order to provide additional context for various aspects of the claimed subject matter, FIG. 11 and the following discussion are intended to provide a brief, general description of a suitable operating environment 1110 in which various aspects described herein may be implemented. While the claimed subject matter is described in the general context of computer-executable instructions, such as program modules, executed by one or more computers or other devices, those skilled in the art will recognize that aspects described herein can also be implemented in combination with other program modules and/or as a combination of hardware and software.

Generally, however, program modules include routines, programs, objects, components, data structures, etc. that perform particular tasks or implement particular data types. The operating environment 1110 is only one example of a suitable operating environment and is not intended to suggest any limitation as to the scope of use or functionality of the claimed subject matter. Other well known computer systems, environments, and/or configurations that may be suitable for use with aspects described herein include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 11, an exemplary environment 1110 for implementing various claimed aspects includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/nonremovable, volatile/nonvolatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

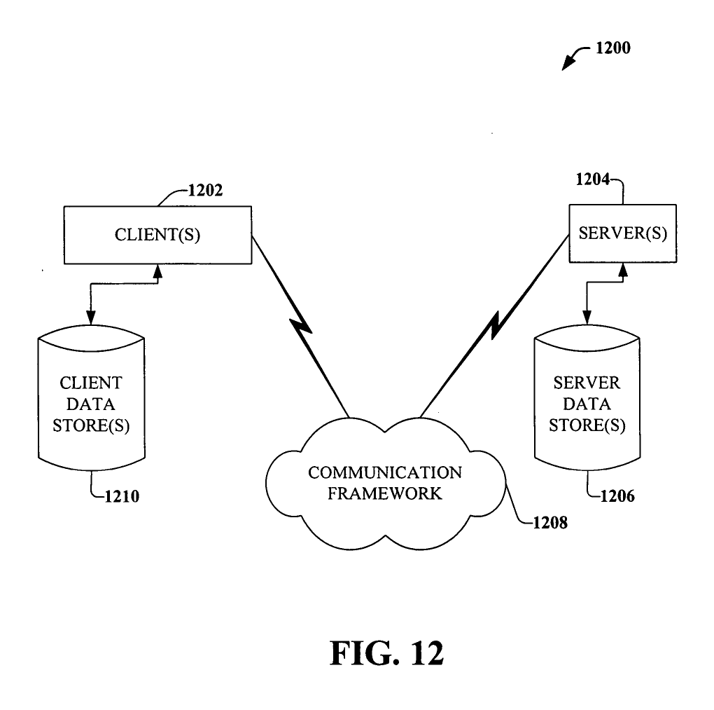

FIG. 12 is a schematic block diagram of a sample-computing environment 1200 with which the claimed subject matter can interact. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations. One possible communication between a client 1210 and a server 1230 can be in the form of a data packet adapted to be transmitted between two or more computer processes. The system 1200 includes a communication framework 1250 that can be employed to facilitate communications between the client(s) 1210 and the server(s) 1230. The client(s) 1210 are operably connected to one or more client data store(s) 1260 that can be employed to store information local to the client(s) 1210. Similarly, the server(s) 1230 are operably connected to one or more server data store(s) 1240 that can be employed to store information local to the servers 1230.

What has been described above includes examples of the claimed subject matter. It is, of course, not possible to describe every conceivable combination of components or methodologies for purposes of describing such claimed matter, but one of ordinary skill in the art may recognize that many further combinations and permutations are possible. Accordingly, features described herein are intended to embrace all such alterations, modifications, and variations that fall within the spirit and scope of the appended claims. Furthermore, to the extent that the term “Includes” is used in either the detailed description or the claims, such term is intended to be inclusive in a manner similar to the term “comprising” as “comprising” is interpreted when employed as a transitional word in a claim.

What is claimed is:

1. A computer implemented system that facilitates search comprising the following computer executable components:
a context engine component that saves information related to at least one of a user state, context, intent, and application state; and
a search component that performs a search in connection with the context component to search for information to assist a user to obtain information associated with interacting with a user application.

2. The system of claim 1, the information is at least one of operating system information, program information, menu information, and historical information.

3. The system of claim 1, the search component searches at least one of an application help database and the Internet.

4. The system of claim 1, the search component is at least one of a search engine associated with the user application, a search engine associated with the application developer, and a third party search engine.

5. The system of claim 1, further comprising a query edit component that allows the user to modify search parameters.

6. The system of claim 5, the query edit component allows the user to at least one of supplement context engine information, remove context engine information, narrow a list of searchable sites, and broaden a list of searchable sites.

7. The system of claim 1, further comprising an application help database, the application help database is updated with the results of the search.

8. The system of claim 1, further comprising an advertisement component, the advertisement component facilitates advertising information related to the search.

9. The system of claim 8, the advertising information is at least one of an advertisement, expanded search fields, and information regarding a related program.

10. The system of claim 1, further comprising a graphical user interface component that allows a user to initiate a search.

11. The system of claim 1, further comprising a subscription component that selects a search engine to perform the search.

12. A computer implemented method for performing a search comprising the following computer executable acts:
collecting context specific application information associated with at least one of a user state, context, user intent, and application state;
generating a search query using the context specific application information; and
returning a search query result to a user.

13. The method of claim 11, the context specific application information is at least one of operating system information, program information, menu information, application information, and historical information.

14. The method of claim 11, further comprising updating an application database with the search result.

15. The method of claim 11, further comprising including an advertisement in the search result, the advertisement is related to the context specific information.

16. The method of claim 11, the search query at least one of continuously receives context specific information, continuously performs a search, and continuously caches search results.

17. The method of claim 16, the result is returned to the user upon a user command.

18. The method of claim 16, the search populates an application help database.

19. A context sensitive web search query computer implemented system comprising:
means for generating user context specific information; and
means for executing a search query using the context specific information in connection with dynamically providing user assistance relating to employment of a software application.

20. The system of claim 19, the information is at least one of operating system information, program information, menu information, application information, and historical information
